(19) United States
(12) Patent Application Publication
(10) Pub. No.: US 2021/0013022 A1
(43) Pub. Date: Jan. 14, 2021

(54) MASS SPECTROMETER

(71) Applicant: SHIMADZU CORPORATION, Kyoto-shi (JP)

(72) Inventor: Yusuke Tateishi, Kyoto-shi (JP)

(73) Assignee: SHIMADZU CORPORATION, Kyoto-shi (JP)

(21) Appl. No.: 16/881,131

(22) Filed: May 22, 2020

(30) Foreign Application Priority Data
Jul. 10, 2019 (JP) 2019-128722

(51) Int. Cl. H01J 49/42; G01N 30/72; H01J 49/00; H01J 49/40; H01J 49/02

(52) U.S. Cl. CPC H01J 49/427; G01N 30/7233; H01J 49/022; H01J 49/4225; H01J 49/40; H01J 49/0036

(57) ABSTRACT

Provided is a mass spectrometer which repeats the operation of capturing ions originating from a sample component into an ion trap (22), ejecting the ions from the ion trap, and analyzing the ions with a TOF mass analyzer (23). A capturing voltage generator (51) applies an ion-capturing radio-frequency voltage to the ion trap. An ejecting voltage generator (52) applies an ion-ejecting voltage whose phase is synchronized with the radio-frequency voltage. A controller (4) controls those devices to introduce next ions to be analyzed into the ion trap while performing a mass spectrometric analysis in the TOF mass analyzer. A blank signal acquirer (4, 32) acquires a blank signal within a measurement period or measurement window while the ion trap is being operated. A noise remover (33) subtracts blank-signal data from signal intensity data acquired by a sample measurement. A spectrum creator (34) creates a mass spectrum based on noise-removed data.

### TECHNICAL FIELD

The present invention relates to a mass spectrometer, and more specifically, to an ion trap time-of-flight mass spectrometer.

### BACKGROUND ART

An ion trap time-of-flight mass spectrometer (which may be hereinafter called the “IT-TOFMS”) includes an ion trap configured to capture ions by the effect of a radio-frequency electric field, and a time-of-flight mass analyzer (which is hereinafter called the “TOF mass analyzer”) configured to detect ions after separating the ions according to their mass-to-charge ratios m/z. In the IT-TOFMS, target ion species originating from a component in a sample are temporarily captured within the ion trap. The ion species are released from the ion trap at a predetermined timing and introduced into the flight space in the TOF mass analyzer. After the flight in the flight space, the ion species are detected by a detector, and a time-of-flight spectrum showing the relationship between time of flight and ion intensity is determined. The time of flight is converted into mass-to-charge ratio to create a mass spectrum.

In the case where an IT-TOFMS is used as the detector for the liquid chromatograph (LC) or gas chromatograph (GC) (see Patent Literature 1 or other related documents), it is necessary for the IT-TOFMS to repeatedly perform a mass spectrometric analysis on a sample which contains various components temporally separated by a column in the LC or GC. In that case, a cycle of processes is repeatedly performed under predetermined conditions, in which one cycle normally includes three processes, as shown in FIG. 2A: an ion accumulation process in which ions generated from a sample component in an ion source are captured into the ion trap; a cooling process in which the amount of energy of the ions accumulated within the ion trap is decreased; and an analyzing process (in FIG. 2A, the “TOF mass spectrometry” process) in which the ions are ejected from the ion trap and detected after being separated from each other in the TOF mass analyzer.

In the case where an IT-TOFMS is used as the detector for an LC or GC, a sample to be subjected to the measurement is continuously introduced into the IT-TOFMS. In the case where the IT-TOFMS is operated so that the next cycle is performed after the completion of one cycle as shown in FIG. 2A, only the sample introduced into the IT-TOFMS during the period of the ion accumulation process is subjected to the measurement; the components in the sample introduced into the IT-TOFMS within the other periods are not subjected to the measurement. That is to say, some components are omitted in the measurement. The longer the period of time for the analyzing process is, the longer the period of time required for one cycle becomes. The period of time for the analyzing process increases with the flight distance of the ions in the TOF mass analyzer. Therefore, a reflection TOF mass analyzer requires a longer period of time for one cycle than a linear TOF mass analyzer. A multiturn TOF mass analyzer requires an even longer period of time for one cycle, so that the problem of the omission of the component in the measurement is more noticeable.

One commonly known measure to avoid this problem is to perform a measurement in which the periods of the successive cycles are partially overlapped with each other. FIG. 2B shows an example in which the ion accumulation process and the cooling process of the next cycle are performed while the analyzing process of one cycle is still ongoing. In this example, there is no overlap between the period of the analyzing process of one cycle and that of another cycle. However, an overlap of the period of the analyzing process between different cycles may be allowed if the ion species ejected from the ion trap in one cycle can be separated from those ejected in another cycle in the TOF mass analyzer. By performing a measurement with a partial overlap of the periods of the analyzing processes of the successive cycles, the period of time in which the ion accumulation process is not ongoing can be shortened, and the omission of the component in the measurement can be reduced.

### CITATION LIST

### Patent Literature

Patent Literature 1: WO 2009/095957 A

Patent Literature 2: JP 2011-96542 A

### SUMMARY OF INVENTION

### Technical Problem

However, a measurement in which the periods of the successive cycles are partially overlapped with each other has a problem as follows.

In a normal type of ion trap, a sinusoidal radio-frequency voltage is applied to one or more electrodes among the plurality of electrodes forming the ion trap. A radio-frequency electric field for capturing ions is thereby created within the space surrounded by those electrodes to contain ions. Meanwhile, in recent years, a digital type of ion trap which uses a rectangular voltage in place of the sinusoidal voltage has been developed (such an ion trap may hereinafter be called the “digital ion trap” according to conventions). Digital ion traps have the advantage that the frequency and/or voltage value of the ion-capturing voltage can be easily and quickly changed since the rectangular voltage can be generated by switching a high DC voltage with a switching element. Adaptation to a high voltage and high frequency can also be more easily realized than in the case of the conventional analogue type of ion trap.

However, due to the nature of its waveform, the rectangular voltage waveform contains a larger amount of radio-frequency component than a sinusoidal voltage waveform of the same frequency. Therefore, when a rectangular voltage is used as the capturing voltage, the radio-frequency noise originating from the capturing voltage is likely to be superposed on the output signal from the detector or similar signal. When the analyzing process is simultaneously performed with the ion accumulation process and/or cooling process due to a partial overlap of the periods of the successive cycles as described earlier, the radio-frequency noise originating from the capturing voltage is superposed on the time-of-flight spectrum signal, causing a decrease in signal-to-noise ratio as well as qualitative deterioration of the mass spectrum. Although such noise can be removed to a certain extent by a contrived wiring design or addition of a noise filter or similar parts, it is difficult to completely remove the noise. Furthermore, an additional cost is required for such a measure.

The present invention has been developed to solve the previously described problem. Its objective is to provide a mass spectrometer which can acquire signal intensity data with a high level of signal-to-noise ratio and create a high-quality mass spectrum based on those data while allowing a partial overlap of the periods of the successive cycles.

### Solution to Problem

One mode of the present invention developed for solving the previously described problem is a mass spectrometer including an ion trap configured to capture an ion by a radio-frequency electric field and a time-of-flight mass analyzer configured to perform a mass spectrometric analysis on an ion ejected from the ion trap, the mass spectrometer configured to repeatedly perform the operation of capturing an ion originating from a sample component into the ion trap, ejecting the ion from the ion trap and analyzing the ion with the time-of-flight mass analyzer, and the mass spectrometer including:

a capturing voltage generator configured to apply an ion-capturing radio-frequency voltage to at least one of the electrodes forming the ion trap;

an ejecting voltage generator configured to apply an ion-ejecting voltage to at least one of the electrodes forming the ion trap, where the phase of the ion-ejecting voltage is synchronized with the phase of the radio-frequency voltage;

a controller configured to control the capturing voltage generator and the ejecting voltage generator so as to introduce an ion to be subsequently analyzed into the ion trap, and capture the ion within the ion trap, while performing the mass spectrometric analysis in the time-of-flight mass analyzer for an ion already ejected from the ion trap;

a blank signal acquirer configured to acquire a blank signal over a predetermined time range within a measurement period from the point in time of ion ejection to the point in time of the completion of one measurement, or within a measurement window which is a portion of the measurement period, while the ion trap is operated in a similar manner to an operation for a measurement of an ion originating from a sample under a control of the controller, and to store the blank signal as blank-signal data;

a noise remover configured to subtract the blank-signal data from signal intensity data in accordance with a lapse time within the measurement period or the measurement window, where the signal intensity data are acquired for a measurement-target sample under a control of the controller by the time-of-flight mass analyzer within the measurement period or a measurement period corresponding to the measurement window; and

a spectrum creator configured to create a mass spectrum based on the signal intensity data after noise removal by the noise remover.

### Advantageous Effects of Invention

In the mass spectrometer according to the previously described mode of the present invention, the ion trap is normally a linear type or three-dimensional quadrupole type of ion trap. In any case, the ion trap captures ions by a radio-frequency electric field.

The capturing voltage applied to the electrodes of the ion trap in order to create a radio-frequency electric field for capturing ions, and the ejecting voltage applied to the electrodes of the ion trap in order to eject ions from the ion trap, have their respective phases maintained in a predetermined relationship with each other as well as synchronized with each other. Since the phase of the radio-frequency noise superposed on the output signal from the detector is synchronized with that of the ion-capturing radio-frequency voltage, the noise is a reproducible noise which is constantly synchronized with the timing of the ejecting voltage. Therefore, it is possible to consider that noise components having approximately the same waveform are superposed on both the blank-signal data and the signal intensity data acquired for a target sample within the same measurement period or measurement window determined by the timing of the ejecting voltage. Accordingly, the noise remover subtracts blank signal data from signal intensity data at each point in time within the same measurement period or measurement window, whereby signal intensity data from which the noise component originating from the capturing voltage is almost removed can be obtained.

By the mass spectrometer according to the previously described mode of the present invention, even when the periods of the successive cycles are made to partially overlap each other so that the ion-capturing operation is performed in the ion trap while a mass spectrometric analysis is being performed in the time-of-flight mass analyzer, a mass spectrum which is free from the influence of, or less affected by the radio-frequency noise originating from the capturing voltage applied to the electrodes of the ion trap can be obtained. This improves the quality of the mass spectrum and enhances the mass accuracy, mass-resolving power, detection sensitivity and other analytical features. Since the radio-frequency noise originating from the capturing voltage can be removed by data processing, the burden of the hardware-based noise control measure, such as a contrived wiring design or addition of noise control parts, can be reduced.

### BRIEF DESCRIPTION OF DRAWINGS

FIG. 1 is a configuration diagram of the main components of an LC/IT-TOFMS as one embodiment of the present invention.

FIGS. 2A and 2B are diagrams showing one example of the control sequence in the case of repeatedly performing a cycle including an ion accumulation process, cooling process and analyzing process in an IT-TOFMS.

FIG. 3 is a schematic timing chart showing a relationship between the capturing voltage and the ejecting voltage in the LC/IT-TOFMS according to the present embodiment.

FIG. 4 is a diagram showing one example of the timing of the blank measurement and the sample measurement in the LC/IT-TOFMS according to the present embodiment.

FIGS. 5A-5C are waveform diagrams for explaining the noise removal process in the LC/IT-TOFMS according to the present embodiment.

### DESCRIPTION OF EMBODIMENTS

A liquid chromatograph ion trap time-of-flight mass spectrometer (LC/IT-TOFMS) as one embodiment of the present invention is hereinafter described with reference to the attached drawings.

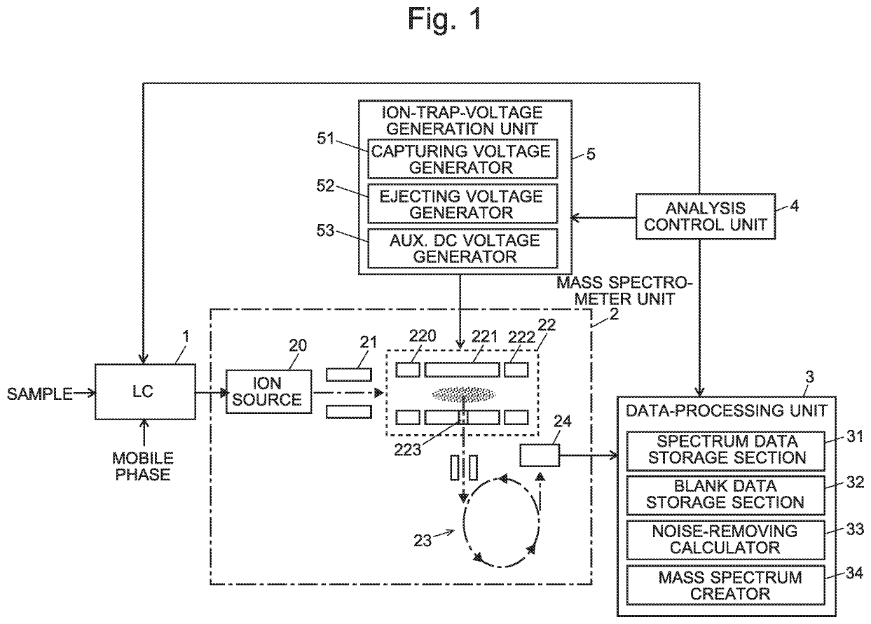

FIG. 1 is a configuration diagram of the main components of the LC/IT-TOFMS according to the present embodiment.

[Overall Configuration of Present Device]The LC/IT-TOFMS includes a liquid chromatograph (LC) 1, mass spectrometer unit 2, data-processing unit 3, analysis control unit 4, and ion-trap-voltage generation unit 5.

Though not shown, the liquid chromatograph 1 is a common type of liquid chromatograph, which typically includes a pump for drawing and sending a mobile phase, an injector for injecting a sample into the mobile phase, a column for temporally separating the components in the sample injected into the mobile phase, as well as a column oven for controlling the temperature of the column.

The mass spectrometer unit 2 includes an ion source 20, ion transport optical system 21, linear ion trap 22, multitum TOF mass analyzer 23, and detector 24. Though not shown, the ion transport optical system 21 and subsequent components are located within a chamber evacuated by vacuum pumps. The ion source 20 is an atmospheric pressure ion source configured to ionize components in a sample liquid under atmospheric pressure, such as an electrospray ion source. The linear ion trap 22 includes an entrance-end electrode 220, main rod electrode 221 and exit-end electrode 222 arranged in the direction in which ions are introduced (rightward in FIG. 1). The entrance-end electrode 220, main rod electrode 221 and exit-end electrode 222 are each composed of four rod electrodes arranged parallel to each other around the linear central axis. An ion ejection opening 223 is formed in one of the four rod electrodes forming the main rod electrode 221.

Although a linear ion trap is used in the present embodiment, it is naturally possible to replace the linear ion trap with a three-dimensional quadrupole ion trap.

Though not shown, the multiturn TOF mass analyzer 23 includes a plurality of sets of inner electrodes and outer electrodes as well as an entrance electrode and exit electrode. The inner and outer electrodes are configured to create a static electric field which makes ions fly in approximately the same loop orbit multiple times. The entrance electrode is used for making ions ejected from the linear ion trap 22 enter the loop orbit, while the exit electrode is used for making the ions flying in the loop orbit leave the same orbit at a predetermined timing and travel toward the detector 24. As is commonly known, the multiturn TOF mass analyzer 23 can achieve a high level of mass-resolving power by increasing the flight distance by making ions fly in the loop orbit a number of times.

The depiction of the multiturn TOF mass spectrometer 23 in FIG. 1 is extremely schematic. Actually, the loop orbit may have various commonly known shapes, such as the 8-shaped orbit or helical orbit. The reason for the use of the multiturn type in the present embodiment to place emphasis on the mass-resolving power. It is evident that a multiple reflection type, reflectron type or linear type may also be used.

The detector 24 includes, for example, a conversion dynode configured to convert ions into electrons and a secondary electron multiplier tube configured to multiply and detect electrons coming from the conversion dynode. The detector 24 generates a detection signal corresponding to the amount of ions it has received, and sends the signal to the data-processing unit 3.

The data-processing unit 3 includes a spectrum data storage section 31, blank data storage section 32, noise-removing calculator 33, and mass spectrum creator 34 as its functional blocks.

The ion-trap-voltage generation unit 5, which is configured to generate voltages applied to the electrodes of the linear ion trap 22, includes a capturing voltage generator 51, ejecting voltage generator 52, auxiliary DC voltage generator 53 and other components. The capturing voltage is a high rectangular voltage. Typically, this voltage can be formed by two levels of high rectangular voltages generated by operating a power-switching element to alternately use a high positive DC voltage and high negative DC voltage generated by two high DC voltage generators of positive and negative polarities.

In common situations, the data-processing unit 3 and analysis control unit 4 are actually a personal computer or similar multipurpose computer, with the previously described functions embodied by executing, on the computer, dedicated controlling-processing software installed on the same computer.

[Description of Analysis Operation for Sample in Present Device]

An operation in the sample measurement in the LC/IT-TOFMS according to the present embodiment is as follows.

In the liquid chromatograph 1 under the control of the analysis control unit 4, a sample is injected at a predetermined timing into the mobile phase supplied to the column. The injected sample is introduced into the column. While passing through the column, the various components in the sample are separated from each other in the temporal direction. Those components exit from the exit end of the column and are introduced into the ion source 20 in the mass spectrometer unit 2. The ion source 20 in the mass spectrometer unit 2 ionizes the components contained in the introduced eluate. The generated ions are transported to the linear ion trap 22 by the ion transport optical system 21.

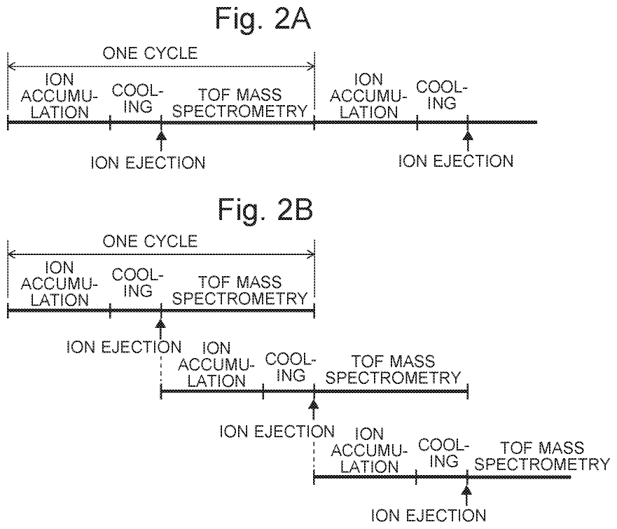

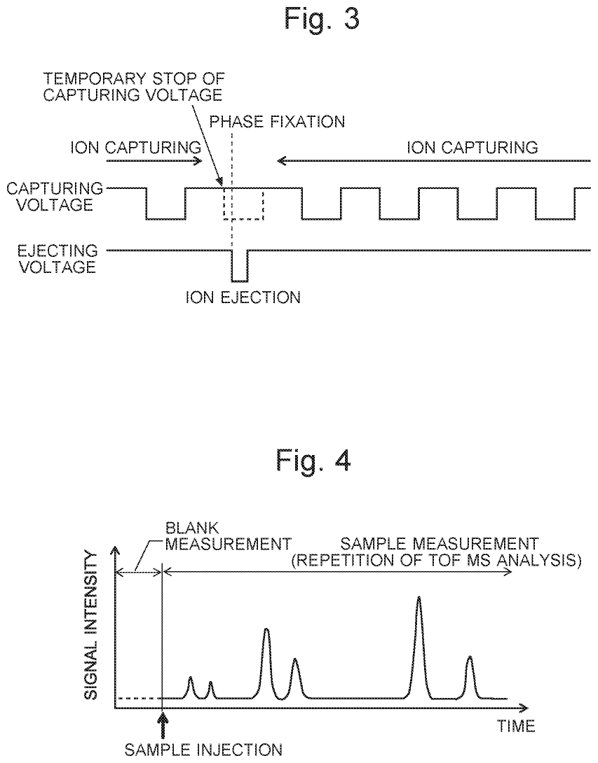

The linear ion trap 22 captures the ions arriving at the trap during a predetermined period of time and accumulates them within the space surrounded by the main rod electrodes 221. This predetermined period of time is the “ion accumulation period” in FIG. 2B. During this period, the capturing voltage generator 51 in the ion-trap-voltage generation unit 5 applies a high rectangular voltage having a predetermined frequency as shown in FIG. 3 to the main rod electrodes 221 as the capturing voltage. This frequency is previously determined according to the range of the mass-to-charge ratios of the ions to be captured as well as other related factors. The auxiliary DC voltage generator 53 in the ion-trap-voltage generation unit 5 applies, to the entrance-end electrode 220, a DC voltage which allows ions to pass through, as well as applies, to the exit-end electrode 222, a DC voltage which repels ions, i.e. a DC voltage which forms a potential barrier against the ions.

Therefore, the ions transferred through the ion transport optical system 21 enter the linear ion trap 22 through the entrance-end electrode 220. Upon arriving at an area near the exit-end electrode 222, the ions are repelled toward the entrance-end electrode 220 and captured by the radio-frequency electric field created within the space surrounded by the main rod electrodes 221. Thus, the ions introduced into the linear ion trap 22 during the ion accumulation period are accumulated within the space surrounded by the main rod electrodes 221.

After the completion of the ion accumulation period, the auxiliary DC voltage generator 53 applies a DC voltage which forms a potential barrier against the ions to the entrance-end electrode 220 as well as the exit-end electrode 222. The ions are thereby confined within the space between the entrance-end electrode 220 and the exit-end electrode 222. In this state, the ions are made to come in contact with the cooling gas (e.g. argon) within the linear ion trap 22 so as to decrease the kinetic energy of the ions. That is to say, the cooling of the accumulated ions is performed. Cooling the ions makes the ions more likely to be collected within a central area in the direction of the central axis of the linear ion trap 22. It also decreases the variation in the ejecting direction at the moment of the ejection of the ions.

After the cooling of the ions is performed for a predetermined period of time, the capturing voltage generator 51 temporarily discontinues the application of the capturing voltage, as shown in FIG. 3. Subsequently, the ejecting voltage generator 52 applies the ejecting voltage to some of the main rod electrodes 221. The ejecting voltage is synchronized with the capturing voltage, with the phase of the waveform of the ion-ejecting pulse constantly maintaining a predetermined relationship with that of the waveform of the capturing voltage. The ejecting voltage imparts kinetic energy to the ions accumulated in the linear ion trap 22 and expels them through the ion ejection opening 223 toward the multiturn TOF mass analyzer 23.

As shown in FIG. 2B, after the ions have been ejected from the linear ion trap 22, the linear ion trap 22 once more begins to accumulate ions. That is to say, as shown in FIG. 3, the capturing voltage is applied to the main rod electrode 221, the DC voltage which allows ions to pass through is applied to the entrance-end electrode 220, and the DC voltage which forms a potential barrier against the ions is applied to the exit-end electrode 222.

The ions ejected from the linear ion trap 22 by the ejecting voltage are guided into the loop orbit by the entrance electrode in the multiturn TOF mass analyzer 23 and begin to fly in the loop orbit. If there are ions having different mass-to-charge ratios mixed together, those ions will be separated from each other in the direction of their travel while flying in the loop orbit. At a specific point in time, e.g. when a specified period of time has passed since the ejection of the ions, the ions flying in the loop orbit are made to leave the loop orbit through the exit electrode and enter the detector 24. The period of time from the point in time where the ions are ejected to the point in time where all ions introduced into the loop orbit arrive at and are detected by the detector 24 is the period of the “TOF mass spectrometry” in FIG. 2B.

The detector 24 generates a detection signal corresponding to the amount of ions it has received, and sends it to the data-processing unit 3. The spectrum data storage section 31 in the data-processing unit 3 digitizes the detection signal, converts it into ion-intensity data, and stores the data as time-of-flight spectrum data in which each piece of ion-intensity data is related to the time of flight measured from the point in time of the ejection of the ions.

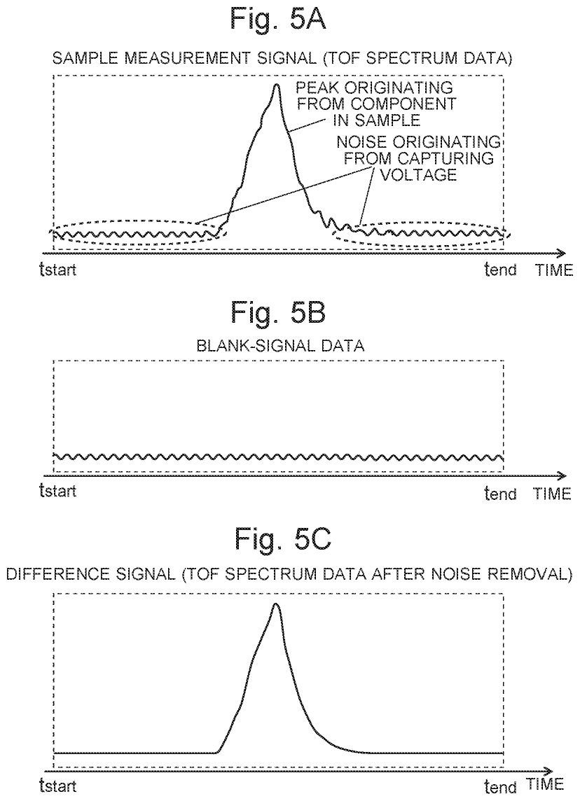

As shown in FIG. 2B, the ion accumulation and ion cooling are also performed within the TOF mass spectrometry period in the present case, with the rectangular capturing voltage being applied from the capturing voltage generator 51 to the main rod electrodes 221 of the linear ion trap 22. Therefore, the radio-frequency noise originating from the capturing voltage is superposed on the detection signal, so that the signal waveform (profile waveform) created from the time-of-flight spectrum data includes the radio-frequency noise originating from the capturing voltage and superposed on the peak waveform, as shown in the example of FIG. 5A. Using such time-of-flight spectrum data as the basis for creating a mass spectrum leads to qualitative deterioration of the mass spectrum, such as a significant number of low noise peaks occurring on the mass spectrum. To address such a problem, the LC/IT-TOFMS according to the present embodiment can create a mass spectrum free from the influence of the radio-frequency noise originating from the capturing voltage, as will be hereinafter described.

The time range from tₛₜₐᵣₜ to t_{end} shown in FIG. 5A may be a time range in which tstart is the timing of the ejection of the ions and t_{end} is the point in time where the measurement is completed, or a time range in which tₛₜₐᵣₜ is a point in time that is a predetermined length of time later than the timing of the ejection of the ions and t_{end} is the point in time where the measurement is completed. That is to say, the time-of-flight spectrum data may be a set of data which covers the entire measurement period starting from the point in time of the ejection of the ions, or a set of data acquired within a measurement window having a predetermined width of time synchronized with the ejection of the ions. In normal situations, in a multiturn TOF mass analyzer, there is no ion introduced to the detector until the point in time where the ions flying in the loop orbit are made to leave the orbit. Therefore, necessary data can be collected by setting the measurement window at a point in time that is not earlier than the point in time where the ions are made to leave the loop orbit.

[Description of Operation for Removing Radio-Frequency Noise in Present Device]

As described earlier, the ejecting voltage is synchronized with the capturing voltage, and the radio-frequency noise superposed on the time-of-flight spectrum data originates from the capturing voltage. Therefore, the radio-frequency noise superposed on the time-of-flight spectrum data can be considered to be a reproducible noise synchronized with the timing of the ejecting voltage. This holds true regardless of whether or not the ions to be analyzed are present in the linear ion trap 22 and the multiturn TOF mass analyzer 23. Accordingly, in the LC/IT-TOFMS according to the present embodiment, blank data (blank signal) in which only the noise component is effectively observed is acquired before a measurement of a sample is performed. The blank data is stored in the blank data storage section 32.

FIG. 4 is one example of the chromatogram acquired with the LC/IT-TOFMS according to the present embodiment. As shown in FIG. 4, under the control of the analysis control unit 4, a blank measurement period is provided before the sample injection in the liquid chromatograph 1. During this period, a set of time-of-flight spectrum data over the entire measurement period, or over a measurement window, is acquired, with the linear ion trap 22 being operated in the same manner as in the sample measurement. The time range (from tₛₜₐᵣₜ to t_{end}) of the time-of-flight spectrum data to be acquired during this period is set to be the same as the time range of the time-of-flight spectrum data to be acquired in the sample measurement.

The blank signal acquired in the blank measurement only needs to be a signal in which no ion originating from the sample components is observed, or a signal in which an ion may possibly be observed but its ion intensity is sufficiently lower than that of the noise signal originating from the ion-capturing radio-frequency voltage. Accordingly, for example, the operations of the ion source 20, ion transport optical system 21 and other components may be stopped during the blank measurement so that no ion enters the linear ion trap 22. Alternatively, those components may be operated as in the normal measurement so as to introduce ions into the multiturn TOF mass analyzer 23 while the mass analyzer 23 is operated to disperse or block the ions in the middle of their flight.

On the time-of-flight spectrum data (blank data) acquired in the blank measurement, no peak originating from sample components appears; instead, the radio-frequency noise originating from the capturing voltage applied to the linear ion trap 22 is mainly observed. For example, its signal waveform will be as shown in FIG. 5B. For the previously described reason, the waveform of the radio-frequency noise observed on this blank data can be considered to be approximately the same as that of the radio-frequency noise superposed on the time-of-flight spectrum data obtained by a sample measurement. Accordingly, every time a set of time-of-flight spectrum data corresponding to a component in the sample is acquired by the sample measurement in the previously described manner, the noise-removing calculator 33 subtracts the blank data stored in the blank data storage section 32 from the time-of-flight spectrum data.

That is to say, for each piece of time-of-flight spectrum data acquired by the sample measurement, the subtraction of the signal intensity of the blank data acquired at the same lapse time measured from the timing of the ejecting voltage is performed over the entire measurement period or entire measurement window. By this operation, the radio-frequency noise superposed on the time-of-flight spectrum data acquired by the sample measurement is almost completely removed, and a set of data representing an almost noise-free signal waveform is obtained, as shown in FIG. 5C. Based on the time-of-flight spectrum data from which the radio-frequency noise has been removed, the mass spectrum creator 34 performs the conversion of the time of flight into mass-to-charge ratio as well as other operations to create a mass spectrum. Thus, a high-quality mass spectrum which is almost free from the influence of the radio-frequency noise originating from the capturing voltage can be obtained.

The device in the previous embodiment performs the blank measurement in advance of the sample measurement. The timing to perform the blank measurement is not limited to this one; for example, the blank measurement may be performed after the completion of the sample measurement. Understandably, this has the disadvantage that a high-quality mass spectrum is not available in real time during the sample measurement period, since the process of removing the high-frequency noise cannot be performed until the completion of the blank measurement.

The configuration of the LC/IT-TOFMS according to the previous embodiment can be modified into appropriate forms other than the previously described one. As a specific example, a front mass separator (e.g. quadrupole mass filter) and a collision cell may be arranged between the ion source 20 and the linear ion trap 22. In this case, an ion (precursor ion) having a specific mass-to-charge ratio selected by the front mass separator is dissociated in the collision cell, and the thereby generated product ions are accumulated in the linear ion trap 22 and subjected to mass spectrometry in the multiturn TOF mass analyzer 23.

The ionization technique in the ion source 20 is not limited to the electrospray ionization (ESI). For example, in the case where a liquid chromatograph is connected in front of the mass spectrometer unit 2 as in the previous embodiment, an ion source which employs atmospheric pressure chemical ionization, atmospheric pressure photoionization or similar methods may be used. In the case where a gas chromatograph is connected to in front of the mass spectrometer unit 2, an ion source which employs electron ionization, chemical ionization, photoionization or similar methods is used. In the case where the sample is in a solid form or powdery form, it is possible to use an ion source which employs matrix assisted laser desorption/ionization, laser desorption/ionization, surface assisted laser desorption/ionization or similar methods. Understandably, ion sources which employ various other ionization methods may also be used.

In the LC/IT-TOFMS according to the previous embodiment, the capturing voltage for capturing ions within the linear ion trap 22 is a rectangular voltage. Even in the case where the capturing voltage is a sinusoidal voltage, the present invention can similarly be applied if the capturing voltage is synchronized with the ejecting voltage. As noted earlier, in the case where the capturing voltage is a sinusoidal voltage, the amount of radio-frequency noise superposed on the time-of-flight spectrum data is considerably smaller than in the case where the capturing voltage is a rectangular voltage. Therefore, the extent of the effect of the present invention will naturally be different.

It should also be naturally understood that any change, addition or modification appropriately made within the spirit of the present invention in any respect other than the previously described ones will fall within the scope of claims of the present application.

[Various Modes]

It should be understood by a person skilled in the art that the previously described illustrative embodiment is a specific example of the following modes of the present invention.

(Clause 1) A mass spectrometer according to one mode of the present invention is a mass spectrometer including an ion trap configured to capture an ion by a radio-frequency electric field and a time-of-flight mass analyzer configured to perform a mass spectrometric analysis on an ion ejected from the ion trap, the mass spectrometer configured to repeatedly perform the operation of capturing an ion originating from a sample component into the ion trap, ejecting the ion from the ion trap and analyzing the ion with the time-of-flight mass analyzer, and the mass spectrometer including:

a capturing voltage generator configured to apply an ion-capturing radio-frequency voltage to at least one of the electrodes forming the ion trap;

an ejecting voltage generator configured to apply an ion-ejecting voltage to at least one of the electrodes forming the ion trap, where the phase of the ion-ejecting voltage is synchronized with the phase of the radio-frequency voltage;

a controller configured to control the capturing voltage generator and the ejecting voltage generator so as to introduce an ion to be subsequently analyzed into the ion trap, and capture the ion within the ion trap, while performing the mass spectrometric analysis in the time-of-flight mass analyzer for an ion already ejected from the ion trap;

a blank signal acquirer configured to acquire a blank signal over a predetermined time range within a measurement period from the point in time of ion ejection to the point in time of the completion of one measurement, or within a measurement window which is a portion of the measurement period, while the ion trap is operated in a similar manner to an operation for a measurement of an ion originating from a sample under a control of the controller, and to store the blank signal as blank-signal data;

a noise remover configured to subtract the blank-signal data from signal intensity data in accordance with a lapse time within the measurement period or the measurement window, where the signal intensity data are acquired for a measurement-target sample under a control of the controller by the time-of-flight mass analyzer within the measurement period or a measurement period corresponding to the measurement window; and

a spectrum creator configured to create a mass spectrum based on the signal intensity data after noise removal by the noise remover.

By the mass spectrometer described in Clause 1, even when the ion-capturing operation is performed in the ion trap while a mass spectrometric analysis is being performed in the time-of-flight mass analyzer, a mass spectrum which is free from the influence of, or less affected by the radio-frequency noise originating from the capturing voltage applied to the electrodes of the ion trap can be obtained. This improves the quality of the mass spectrum and enhances the mass accuracy, mass-resolving power, detection sensitivity and other analytical features. Since the radio-frequency noise originating from the capturing voltage can be removed by data processing, the burden of the hardware-based noise control measure, such as a contrived wiring design or addition of noise control parts, can be reduced.

(Clause 2) In the mass spectrometer described in Clause 1, the ion-capturing radio-frequency voltage may be a rectangular voltage.

In the mass spectrometer described in Clause 1, the ion-capturing radio-frequency voltage may be either a rectangular voltage or sinusoidal voltage. Due to the nature of its waveform, the rectangular voltage contains a larger amount of radio-frequency (harmonic) component than the sinusoidal voltage, and therefore, is more likely to cause the problem of radio-frequency noise. Accordingly, the noise removal process in which the blank signal data acquired by the blank measurement is subtracted from signal intensity data acquired by a measurement on a sample is particularly useful in the mass spectrometer described in Clause 2.

(Clause 3) In the mass spectrometer described in Clause 1 or 2, the time-of-flight mass analyzer may be a multiturn time-of-flight mass analyzer configured to make an ion repeatedly fly in a substantially identical flight orbit a plurality of times.

In the mass spectrometer described in Clause 1, the time-of-flight mass analyzer may have any type of configuration, such as a linear type, reflectron type, multiple reflection type, or multiturn type. The previously described problem of the omission of the component in the measurement becomes more noticeable as the period of time for the TOF mass spectrometric analysis becomes longer due to a long flight distance. In this respect, the noise removal process in which the blank signal data acquired by the blank measurement is subtracted from signal intensity data acquired by a measurement on a sample is particularly useful in the mass spectrometer described in Clause 3.

### REFERENCE SIGNS LIST

1 . . . Liquid Chromatograph (LC)
2 . . . Mass Spectrometer Unit
20 . . . Ion Source
21 . . . Ion Transport Optical System
22 . . . Linear Ion Trap
220 . . . Entrance-End Electrode
221 . . . Main Rod Electrode
222 . . . Exit-End Electrode
223 . . . Ion Ejection Opening
23 . . . Multitum TOF Mass Analyzer
24 . . . Detector
3 . . . Data-Processing Unit
31 . . . Spectrum Data Storage Section
32 . . . Blank Data Storage
33 . . . Noise-Removing Calculator
34 . . . Mass Spectrum Creator
4 . . . Analysis Control Unit
5 . . . Ion-Trap-Voltage Generation Unit
51 . . . Capturing Voltage Generator
52 . . . Ejecting Voltage Generator
53 . . . Auxiliary DC Voltage Generator

1. A mass spectrometer including an ion trap configured to capture an ion by a radio-frequency electric field and a time-of-flight mass analyzer configured to perform a mass spectrometric analysis on an ion ejected from the ion trap, the mass spectrometer configured to repeatedly perform an operation of capturing an ion originating from a sample component into the ion trap, ejecting the ion from the ion trap and analyzing the ion with the time-of-flight mass analyzer, and the mass spectrometer comprising:
a capturing voltage generator configured to apply an ion-capturing radio-frequency voltage to at least one of the electrodes forming the ion trap;
an ejecting voltage generator configured to apply an ion-ejecting voltage to at least one of the electrodes forming the ion trap, where a phase of the ion-ejecting voltage is synchronized with a phase of the radio-frequency voltage;
a controller configured to control the capturing voltage generator and the ejecting voltage generator so as to introduce an ion to be subsequently analyzed into the ion trap, and capture the ion within the ion trap, while performing the mass spectrometric analysis in the time-of-flight mass analyzer for an ion already ejected from the ion trap;
a blank signal acquirer configured to acquire a blank signal over a predetermined time range within a measurement period from a point in time of ion ejection to a point in time of completion of one measurement, or within a measurement window which is a portion of the measurement period, while the ion trap is operated in a similar manner to an operation for a measurement of an ion originating from a sample under a control of the controller, and to store the blank signal as blank-signal data;
a noise remover configured to subtract the blank-signal data from signal intensity data in accordance with a lapse time within the measurement period or the measurement window, where the signal intensity data are acquired for a measurement-target sample under a control of the controller by the time-of-flight mass analyzer within the measurement period or a measurement period corresponding to the measurement window; and
a spectrum creator configured to create a mass spectrum based on the signal intensity data after noise removal by the noise remover.

2. The mass spectrometer according to claim 1, wherein the ion-capturing radio-frequency voltage is a rectangular voltage.

3. The mass spectrometer according to claim 1, wherein the time-of-flight mass analyzer is a multiturn time-of-flight mass analyzer configured to make an ion repeatedly fly in a substantially identical flight orbit a plurality of times.

4. The mass spectrometer according to claim 2, wherein the time-of-flight mass analyzer is a multiturn time-of-flight mass analyzer configured to make an ion repeatedly fly in a substantially identical flight orbit a plurality of times.
